(19) United States
(12) Patent Application Publication
(10) Pub. No.: US 2008/0135049 A1
(43) Pub. Date: Jun. 12, 2008

(54) Filtering Means For Suction Tube

(76) Inventor: George Lee, Taipei (TW)

Correspondence Address: HDSL, 4331 STEVENS BATTLE LANE, FAIRFAX, VA, 22033, US

(21) Appl. No.: 11/567,806

(22) Filed: Dec. 7, 2006

(51) Int. Cl. A62B 7/10

(52) U.S. Cl. 128/205.29

(57) ABSTRACT

A filtering means for a suction tube is capable of blocking pollution sources in the air. Such means is mainly made of a tube body. The tube body is formed into an arc and has a first connecting tube and a second connecting tube thereon. A blocking body is received in the first connecting tube for blocking fine particles in the air. Further, an outer cover having a plurality of through holes is provided so as to fix the position of the blocking body. The interior of the second connecting tube is provided with a partition. The surface of the partition is provided with a plurality of gaps thereon. The gaps are formed like a grate to prevent large-sized foreign matters from entering the suction tube. With providing the filtering means on the suction tube, the fine particles contained in the air, the sputa or bacteria contained in the air exhaled by the patient can be blocked when passing through the suction tube.

### BACKGROUND OF THE INVENTION

1. Field of the Invention

The present invention relates to a suction tube, and in particular to a suction tube capable of filtering the impurity in the air.

2. Description of Prior Art

During a general medical procedure, in view of safety, doctor always use a suction tube to remove the sputa existed in the respiratory tract of the patients who cannot remove the sputa by themselves, thereby to keep the respiratory tract unobstructed.

The current suction tube is used to facilitate the removing of the sputa of the patient, and in addition, it can introduce oxygen into the respiratory tract of the patient by being connected to an oxygen-delivering tube, thereby to help the patient to keep breathing. Therefore, in order to combine the suction of sputa and the function of facilitating breathing, the conventional suction tube is provided with a suction valve having a plurality of connecting tubes for connecting the suction tube and the oxygen-delivering tube, or alternatively connecting to the center of other conduits.

Since the suction valve in the above-mentioned suction tube is directly connected to the respiratory tract, the air exhaled by the patient can pass through the respiratory tract and be discharged via the suction tube. Further, since the air exhaled by the patient includes residual bacteria or non-removed sputa, it may become one of the infectious sources when exhausted to the outside.

The current assembly of a suction tube and a suction valve can only open the conduits for the passage of airflow and close the other unused connecting tubes. However, the conventional suction tube is not provided with a means for filtering the air. As a result, not only the air exhaled by the patient may become an infectious pathway easily, but also the fine particles or bacteria contained in the outside air may directly invade and affect the respiratory tract of the patient via such conventional suction tube. As a result, it is an important issue for those skilled in this art to overcome the above-mentioned problems.

### SUMMARY OF THE INVENTION

In view of the above drawbacks, the present invention is to provide a filtering means for a suction tube. With the provision of a partition for blocking larger-sized foreign matters and a blocking body for blocking fine particles and bacteria in the conduits communicating with the suction tube, by using the suction tube as a breathing path, such a double blocking effect can guarantee the safety of the respiratory tract of the patient. Further, it can also guarantee that the air exhaled by the patient will not infect the surrounding people.

In order to achieve the objects, the present invention provides a filtering means for a suction tube. Such means is mainly made of a tube body. The tube body is formed into an arc and has a first connecting tube and a second connecting tube thereon. A blocking body is received in the first connecting tube for blocking fine particles in the air. Further, an outer cover having a plurality of through holes is provided so as to fix the position of the blocking body. The interior of the second connecting tube is provided with a partition. The surface of the partition is provided with a plurality of gaps thereon and the gaps are formed as a grate to prevent large-sized foreign matters from entering the suction tube. With providing the filtering means on the suction tube, the fine particles contained in the air, the sputa or bacteria contained in the air exhaled by the patient can be blocked when passing through the suction tube.

### BRIEF DESCRIPTION OF THE DRAWINGS

FIG. 1 is an exploded perspective view of the present invention;

FIG. 2 is a cross-sectional view of the present invention;

FIG. 3 is a front view of the present invention;

FIG. 4 is an assembled view showing the operation of the present invention;

FIG. 5 is a side view showing the operation of the present invention; and

FIG. 6 is a partial cross-sectional view of the present invention.

### DETAILED DESCRIPTION OF THE INVENTION

The technical contents and the detailed description of the present invention will be made with reference to the accompanying drawings.

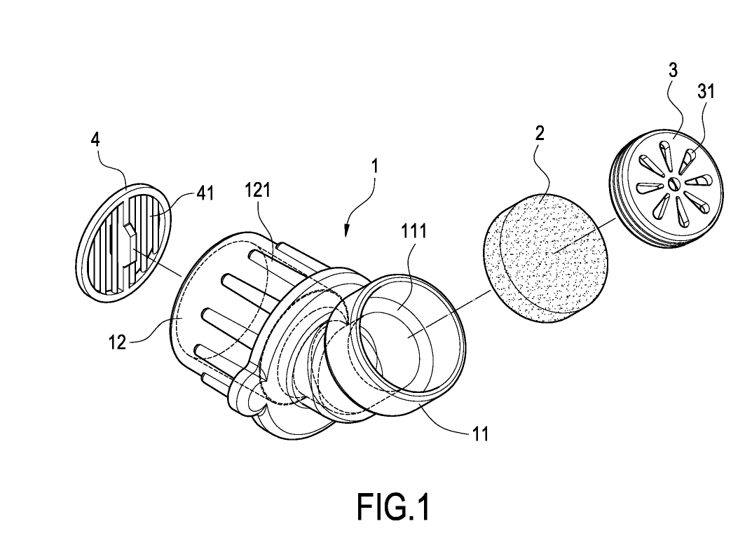

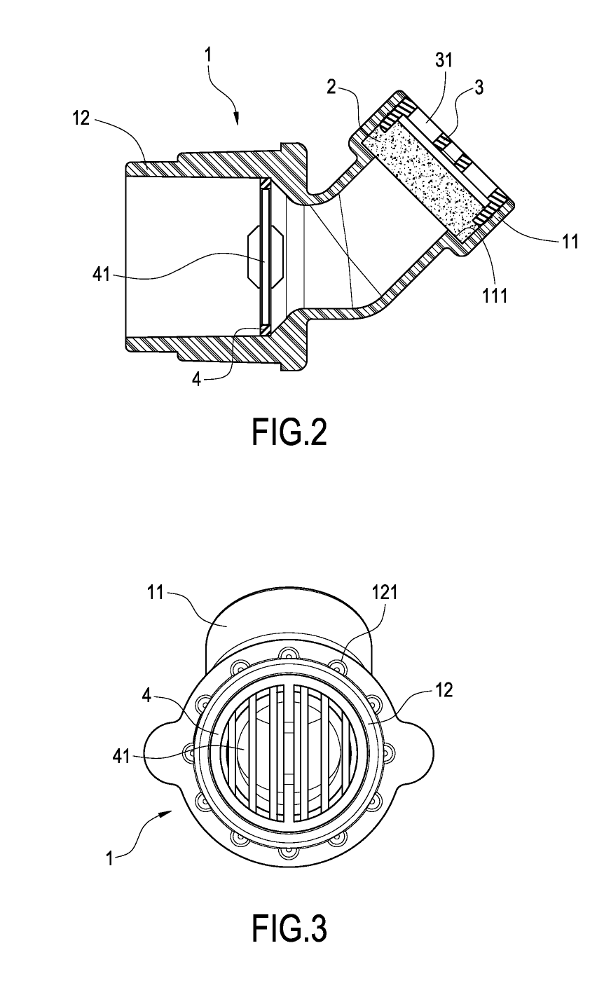

FIG. 1 is an exploded perspective view of the present invention. FIG. 2 is a cross-sectional view of the present invention. FIG. 3 is a front view of the present invention. As shown in the figures, the filtering means of the present invention is mainly formed of a tube body 1. In the present embodiment, the profile of the tube body 1 is formed into an arc. The interior of the tube body 1 is in communication with the outside and provided with a first connecting tube 11 and a second connecting tube 12. The cross section of the mouth of the first connecting tube 11 is formed into a circular shape. The bottom of the inner edge of the first connecting tube 11 has an annular protruding plate 111 that extends radially therefrom. Further, the interior of the first connecting tube 11 is provided with a blocking body 2. In the present embodiment, the blocking body 2 is a sponge of a high density for blocking fine particles and bacteria contained in the air. The profile of the blocking body 2 is formed into a cylindrical body and exactly received within the first connecting tube 11. The bottom end and the outer circumferential surface of the blocking body 2 abut exactly against the annular projecting plate 111 and the inner circumferential surface of the first connecting tube 11, respectively. Finally, an outer cover 3 is disposed to cover the first connecting tube 11. The profile of the cover 3 is formed into a circular shape. The upper end face of the outer cover 3 is provided with a plurality of through holes 31. The through holes 31 penetrate through the body of the outer cover 3 and are formed into an airflow passage in use. In the present embodiment, the through holes 31 are arranged in a radial form. When the outer cover 3 covers the first connecting tube 11, the bottom end of the outer cover 3 abuts exactly against the periphery of the upper end face of the blocking body 2, thereby to fix the position of the blocking body 2.

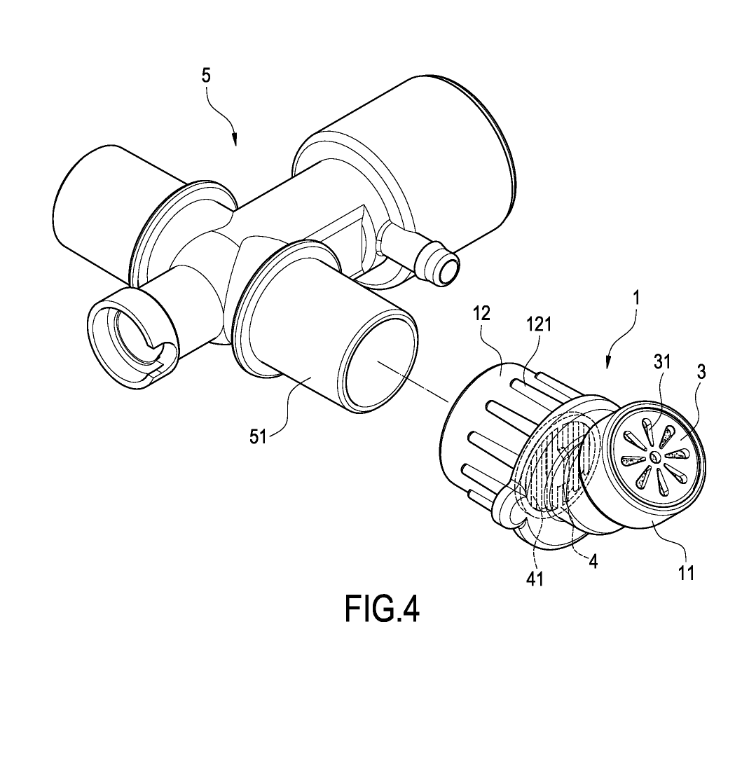

The profile of the second connecting tube 12 is formed into a circular shape for connecting onto a suction valve 5 of the suction tube (as shown in FIG. 4 and described in later). A plurality of spaced protruding posts 121 is provided on the outer circumferential surface of the tube body of the second connecting tube 12. The interior of the second connecting tube 12 is provided with a partition 4 formed into a circular plate. The outer periphery of the partition 4 is disposed to abut against the inner circumferential surface of the second connecting tube 12. Further, the surface of the partition 4 is provided with a plurality of parallel gaps 41 formed as a grate. The gaps are formed to be perpendicular to the mouth of the second connecting tube 12 and thus constitute a substantial airflow path, thereby to block the incoming and outgoing of large-sized foreign matters.

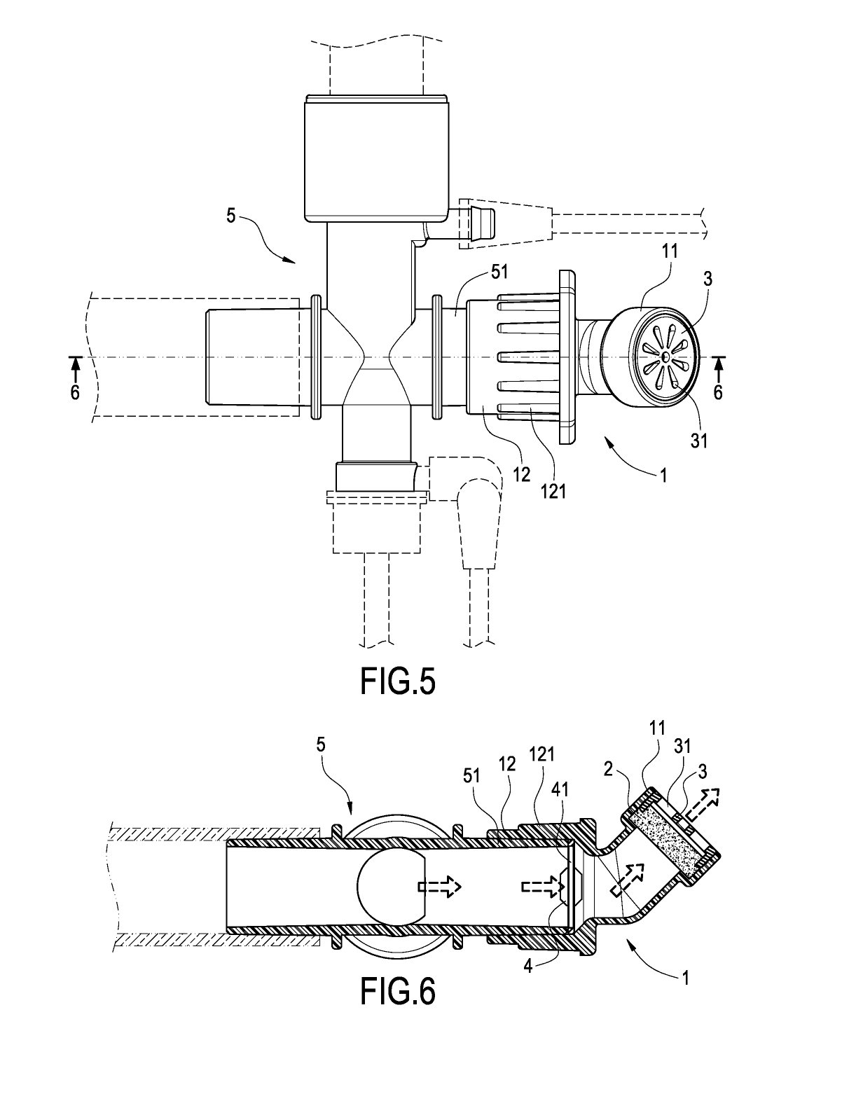

FIG. 4 is an assembled view showing the operation of the present invention. FIG. 5 is a side view showing the operation of the present invention. FIG. 6 is a partial cross-sectional view of the present invention. As shown in the figures, the filtering means of the present invention can be disposed on the suction valve 5 connecting to the suction tube and the air conduit for the patient. As shown in FIG. 4, the second connecting tube 12 of the filtering means is connected to a mouth 51 of the suction valve 5, so that it can be brought into communication with the interior of the suction valve 5. Further, as shown in the side view of FIG. 5, the suction valve 5 is brought into communication with the respiratory tract of the patient, so that the air exhaled from the respiratory tract of the patient can flow through the filtering means. Since the air exhaled by the patient may comprise bacteria or sputa, which may spread out along with the air exhaled by the patient. Therefore, as shown in the direction of arrows in FIG. 6, the air exhaled by the patient first passes through the partition 4 within the second connecting tube 12, large-sized foreign matters such as sputa can be blocked by the partition 4. Then, the thus-passed air flows toward the first connecting tube 11 and passes through the blocking body 2 therein whereby the fine particles or bacteria contained in the air are completely blocked. Finally, the purged air is guided to the outside. In this way, it can be assured that the air exhaled by the patient will not affect the health of other people. Further, the blocking body 2 of the first connecting tube 11 also prevents the fine particles or bacteria contained in the outside air from entering the respiratory tract of the patient, and thus prevents the patient form getting infected.

Although the present invention has been described with reference to the foregoing preferred embodiment, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A filtering means for a suction tube, connected onto the suction tube and comprising:
a tube body having a first connecting body and a second connecting tube;
a blocking body provided in the first connecting tube; and
an outer cover covering on a mouth of the first connecting tube for fixing the blocking body, and the outer cover provided with a plurality of through holes thereon for penetrating through the outer cover, wherein the blocking body acts to block foreign matters, fine particles or bacteria in the air.

2. The filtering means for a suction tube according to claim 1, wherein the second connecting tube is provided with a partition therein, the outer periphery of the partition is disposed to abut against the inner circumferential surface of the second connecting tube, and the partition is provided with a plurality of gaps thereon.

3. The filtering means for a suction tube according to claim 2, wherein the plurality of gaps of the partition is formed in a grate.

4. The filtering means for a suction tube according to claim 1, wherein the profile of the tube body is formed into an arc.

5. The filtering means for a suction tube according to claim 1, wherein the bottom of the inner edge of the first connecting tube has an annular protruding plate that extends radially therefrom.

6. The filtering means for a suction tube according to claim 5, wherein the periphery of the bottom of the blocking body exactly abuts against the annular protruding plate.

7. The filtering means for a suction tube according to claim 1, wherein the blocking body is a sponge of a high density.

8. The filtering means for a suction tube according to claim 1, wherein the profile of the blocking body is formed into a cylindrical shape.

9. The filtering means for a suction tube according to claim 1, wherein the outer circumferential surface of the blocking body exactly abuts against the inner circumferential surface of the first connecting tube.

10. The filtering means for a suction tube according to claim 1, wherein the plurality of through holes of the outer cover are arranged in a radial form.

11. The filtering means for a suction tube according to claim 1, wherein the outer circumferential surface of the second connecting tube is provided with a plurality of spaced protruding posts.
